(19) United States
(12) Patent Application Publication
(10) Pub. No.: US 2009/0112998 A1
(43) Pub. Date: Apr. 30, 2009

(54) Method and Apparatus for Controlling Dissemination of Enterprise Information

(75) Inventor: Valentin Oprescu-Surcobe, Northbrook, IL (US)

Correspondence Address: LEVEQUE INTELLECTUAL PROPERTY LAW, P.C., 221 EAST CHURCH ST., FREDERICK, MD, 21701, US

(73) Assignee: MOTOROLA, INC., Schaumburg, IL (US)

(21) Appl. No.: 11/924,245

(22) Filed: Oct. 25, 2007

(51) Int. Cl. G06F 15/16

(52) U.S. Cl. 709/206

(57) ABSTRACT

Information dissemination in an electronic messaging system is controlled by presenting, to a user, first and second user-action elements. The first element is indicative of whether the first message is to be sent to all recipients in the first distribution list, while the second element is indicative of whether the message is to be sent to a subgroup of the recipients in the first distribution list. If the second element is activated, any recipients that are not also included in a pre-defined set of the recipients are removed from the first distribution list to obtain a second distribution list. If the first element is activated, the message is sent to recipients in the first distribution list. If the second element is activated, the message is sent to recipients in the second distribution list. In one embodiment the first element is a ‘Reply All’ button and the second element is a ‘Reply Subgroup’ button.

### BACKGROUND

Enterprise information is often disseminated via electronic messaging such as electronic mail (e-mail), short message systems (SMS), multimedia messaging system (MMS) and instant messages (IM), for example. It is desirable that the distribution or dissemination of some enterprise information be limited. For example, it may be desirable to provide certain information to a project group covered by a non-disclosure or confidentiality agreement, or to a particular organization, or to a selected group within an organization.

Often, employees of an organization have contacts other than the intended recipients of the information. These recipients may be outside of the organization (customers, service providers, regulators, for example) or outside of a selected group (other employees and consultants, for example).

Information is often conveyed as part of a series of communications, where a person provides enterprise information in response to a first communication. Often, the first communication is sent to a number of recipients on a (possibly large) distribution list.

Some electronic messaging systems (such as e-mail) provide a ‘reply-all’ option that enable a response to be sent to all the people on the distribution list of the first communication. As a result, it is quite common for enterprise information to be sent to people other than those for which the response was intended. This inadvertent dissemination of information may be damaging to the organization or to others.

Some systems attempt to identify potentially irreversible operations and ask users for explicit confirmation prior to proceeding with an operation. Examples include explicit or implicit file deletion operations on a personal computer and electronic financial transactions.

### BRIEF DESCRIPTION OF THE FIGURES

The accompanying figures, in which like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a diagrammatic representation of a communication system in accordance with certain embodiments of the present invention.

FIG. 2 is a flow chart of a method for controlling dissemination of enterprise information in accordance with some embodiments of the invention.

FIG. 3 is a flow chart of a further method for controlling dissemination of enterprise information in accordance with some embodiments of the invention.

FIG. 4 is a flow chart of a still further method for controlling dissemination of enterprise information in accordance with some embodiments of the invention.

FIG. 5 is a diagrammatic representation of an exemplary graphical user interface in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to the control of information dissemination. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

It will be appreciated that embodiments of the invention described herein may comprise one or more conventional processors and unique stored program instructions that control the one or more processors to implement, in conjunction with certain non-processor circuits, some, most, or all of the functions relating to the control of information dissemination described herein. The non-processor circuits may include, but are not limited to, network infrastructure and user input devices. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

One embodiment of the present invention relates to a method for controlling dissemination of information in an electronic messaging system. In accordance with the method, a first distribution list is generated for a message. A first user-action element is presented to a user of the electronic messaging system, the first user-action element being indicative of whether the first message is to be sent to all recipients in the first distribution list. In addition, a second user-action element is presented to the user, the second user-action element being indicative of whether the message is to be sent to a subgroup of the recipients in the first distribution list. If the second user-action element is activated, any recipients that are not included in pre-defined set of the recipients are removed from the first distribution list to obtain a second distribution list. If the first user-action element is activated, the message is sent to recipients in the first distribution list. If the second user-action element is activated, the message is sent to recipients in the second distribution list.

The message may be a response to a received message, in which case the first distribution list is a group of addresses that includes the address of the sender of the received message and addresses of recipients to whom the received message was addressed or copied. For example, the first user-action element may be a ‘Reply All’ element and the second user-action element may be a ‘Reply Subgroup’ element. The subgroup may be recipients that are both in the first distribution list of recipients and also in the same message domain as the user. The address list may be compiled by the user. Alternatively, the subgroup may be recipients that are not in a prohibited domain or on a list of prohibited recipients. Still further, the set of prohibited recipients may be any recipient that is not in a permitted set. For example, the permitted set may be the set of recipients in the same domain as the user.

In one embodiment, the second user-action element comprises an image on a graphical user interface, while in a further embodiment the second user-action element comprises a voice prompt generated by a voice interface.

The electronic message system may be, for example, an electronic mail (email) system, a small message service (SMS), multimedia messaging system (MMS) or instant messaging (IM) system. The message may include elements such as text, voice, diagrams, drawings, icons, images, video clips, audio and/or ring tones.

The removal of unintended recipients may be performed by a network server or by a user device.

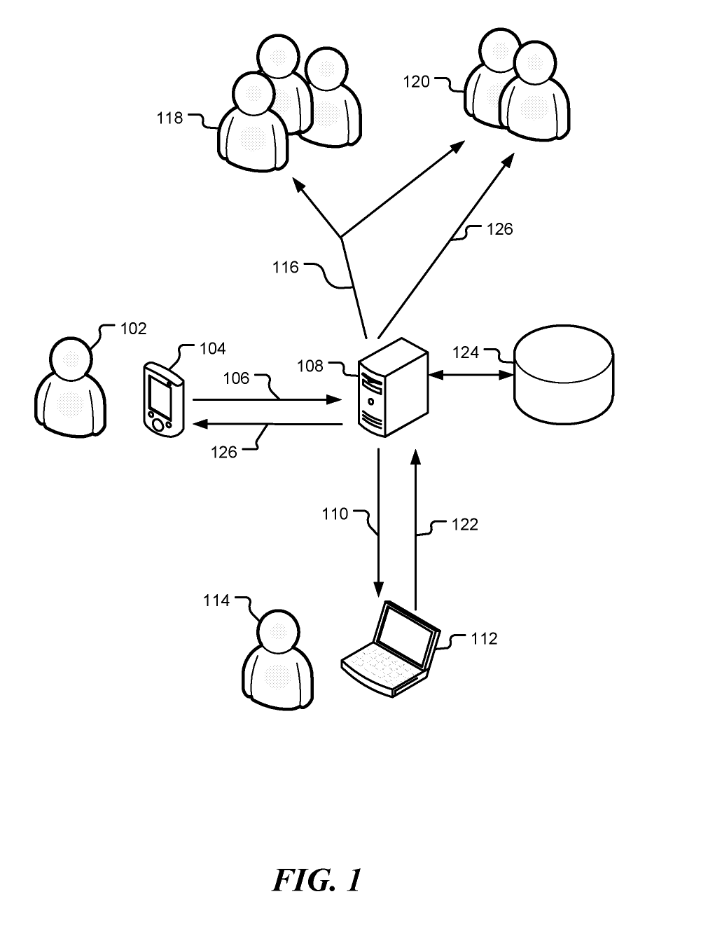

FIG. 1 is a diagrammatic representation of an electronic messaging system in accordance with certain embodiments of the present invention. Referring to FIG. 1, a first user 102 uses an electronic device 104, such a personal computer (PC), personal digital assistant (PDA) or mobile telephone, to send an electronic message 106 over a network. The message includes a distribution list specifying the network addresses or other identifiers of the intended recipients. In this exemplary embodiment, the electronic message 106 is received by a mail server 108. The mail server then delivers a corresponding electronic message 110 to an electronic device 112 a first recipient 114 in the distribution list. In addition, corresponding messages 116 may be delivered to a first group of recipients 118 in the distribution list and to a second group of recipients 120 in the distribution list.

The first recipient 114 may respond to the message 110 with a message 122 that contains information that is only intended for the second group of recipients 120.

In accordance with prior messaging systems, the first recipient 114 may avoid manual entry of all of the addresses of recipients by pressing a ‘reply all’ button on a user interface. While this saves considerable time, it results in the message 122 being sent to the first group of recipients 118, which was not intention of the user. To avoid this, the user 114 must determine the intended group of recipients and then manually enter the intended addresses or delete the unintended addresses.

The user electronic device 112 includes an input for receiving a first distribution list for a first message. In this example, the distribution list is derived from the incoming message. In a further example, the input may be a user interface that allows the user to enter recipient addresses.

In accordance with a first embodiment of the invention, the user interface of the electronic device 112 presents the user 114 with one or more user-action elements to allow the user to reply to a selected subgroup of recipients or to reply to all recipients. For example, a ‘reply-internal’ button may be presented (in addition to a ‘reply-all’ button). If the ‘reply-internal’ button is activated, the response is sent only to those recipients on an internal distribution list (a list of company employees for example). More generally, the user communication device presents a first user-action element, indicative of whether the first message is to be sent to all recipients in the distribution list, and a second user-action element indicative of whether the first message is to be sent to a subgroup of the recipients in the distribution list.

In the embodiment shown in FIG. 1, the internal distribution list is maintained by the mail server 108. The message 122, with a complete distribution list (i.e. the distribution list of message 110 plus the address of the original sender 102), is sent, via an output of the user electronic device 112, to the mail server 108. In one embodiment, the message includes information to instruct the mail server 108 to query a database 124 and to remove the addresses of unintended recipients from the distribution list. In a further embodiment, the message includes information to instruct the mail server to check the domain names of the addresses in the distribution list. As a result, the message 126 is sent to the second recipient group 120 and the original sender 102, but not to the first recipient group 118 that is not on the internal list. Thus, dissemination of the information in the message 122 is controlled. More generally, the system includes a processor that removes from the distribution list, any recipients that are not also included in a pre-defined set of the recipients, to obtain a second distribution list, if the corresponding user-action element is activated.

In a further embodiment, the internal distribution list is maintained on the user electronic device 112, and the distribution list is filtered before the message 122 is sent to the mail server 108. Optionally, the user may be prompted before the unintended addresses are removed from the distribution list.

The user action elements may be, for example, buttons or icons for a graphical user interface, or voice prompts for voice entry interface.

Additional user-action elements may be provided for ‘send’, ‘reply’ and/or ‘forward’ operations. The user action elements allow a user to indicate whether the distribution should be limited to recipients in a selected group or domain.

In a further embodiment, user action elements for selective dissemination may be provided, for example, ‘send all’, send group X’, ‘reply all’, ‘reply group X’, etc, but no lists are maintained. Rather, when ‘send group X’ is selected, the user is prompted to enter the address of recipients in group X, or an alert is provided to remind the user to enter only the intended recipient addresses. This reminds the user to pay attention to the list of recipients.

These above embodiments may be combined, such that the user is reminded to enter only intended recipient addresses, but unintended addresses are removed (possibly after receiving confirmation from the user) before the information is disseminated.

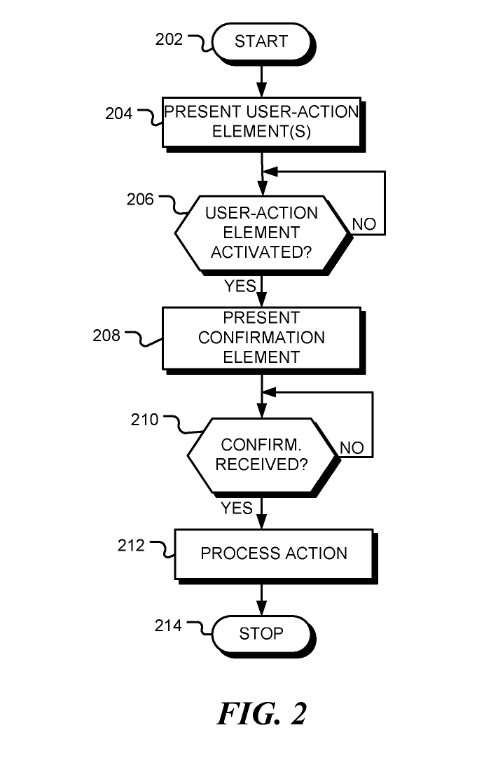

FIG. 2 is a simplified flow chart a method consistent with some embodiments of the invention. Following start block 202, one or more user-action elements are displayed or otherwise presented to the user at block 204. These may be in the form of buttons on a graphical user interface for example. When a user-action element is activated, as indicated by the positive branch from decision block 206, an alert is presented to the user at block 208 to remind him or her that an appropriate action should be perform. For example, if a ‘send internal’ button is pressed, an audible alert may sound and graphical message displayed to prompt the user to check the distribution list for addresses that are not ‘internal’ to the organization. When the user confirms that the distribution list is satisfactory, as indicated by the positive branch from decision block 210, the requested action is performed at block 212. For example, the electronic message may be sent to addresses on the distribution list. The process terminates at block 214.

The method described above, in reference to the flow chart of FIG. 2, reduces the chance of messages and information being inadvertently sent to a wrong recipient.

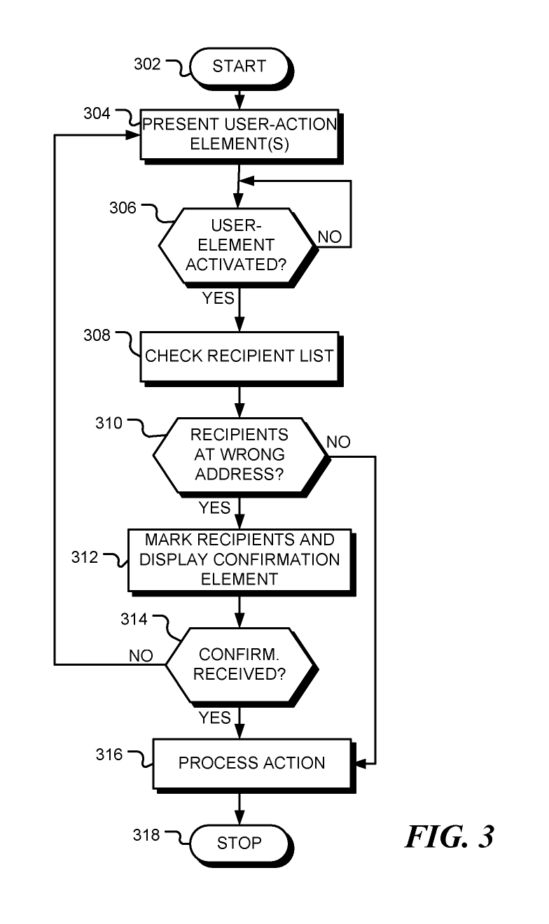

FIG. 3 is a simplified flow chart of a further method consistent with some embodiments of the invention. Following start block 302, one or more user-action elements are displayed or otherwise presented to the user at block 304. These may be in the form of buttons on a graphical user interface for example. When a user-action element is activated, as indicated by the positive branch from decision block 306, the list of addresses in the distribution list of a message is checked at block 308. In one embodiment, the addresses are checked against a list maintained by the user's device or another network device such as the user's mail server. In this embodiment, the full address is checked. For example, in response to a ‘reply group X’ action, the full addresses may be checked against a list of addresses in group X. In a further embodiment, only the domain of the address is checked. For example, in response to a ‘send internal’ action, the domain of each recipient may be checked against the domain of the user.

If non-matching addresses are found in the distribution list, as indicated by the positive branch from decision block 310, the non-matching addresses are disclosed to the user (by high-lighting, color coding or marking, for example) at block 312. If the user confirms that the non-matching addresses are incorrect, as depicted by the positive branch from decision block 314, the addresses are removed and the action is processed at block 316. If the user does not confirm the non-matching addresses, as depicted by the negative branch from decision block 314, flow returns to block 304 and the user may select a different action. If there are no non-matching addresses, as depicted by the negative branch from decision block 310, the action is processed at block 316. The method terminates at block 318.

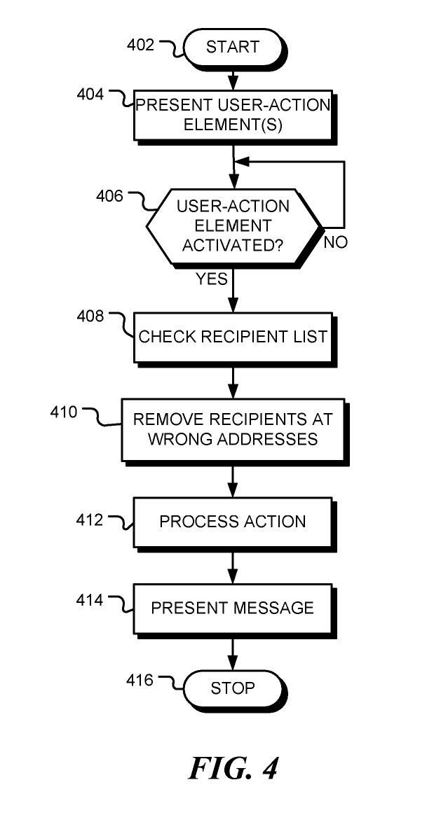

FIG. 4 is a simplified flow chart of a still further method consistent with some embodiments of the invention. Following start block 402, one or more user-action elements are displayed or otherwise presented to the user at block 404. These may be in the form of buttons on a graphical user interface for example. When a user-action element is activated, as indicated by the positive branch from decision block 406, the list addresses in the distribution list of a message is checked at block 408. In one embodiment, the addresses are checked against a list maintained by the user's device or another network device such as the user’ s mail server. In this embodiment, the full address is checked. For example, in response to a ‘reply group X’ action, the full addresses may be checked against a list of addresses in group X. In a further embodiment, only the domain of the address is checked. For example, in response to a ‘send internal’ action, the domain of each recipient may be checked against the domain of the user. The list addresses may be permitted addresses or prohibited addresses, permitted domains or prohibited domains. Unintended recipient addresses are removed from the distribution list at block 410 and the message is processed at block 412. Optionally, a message may be presented to the user at 414, using a graphical or audio interface for example. The message may identify addresses that were removed from the distribution list. The method terminates at block 416.

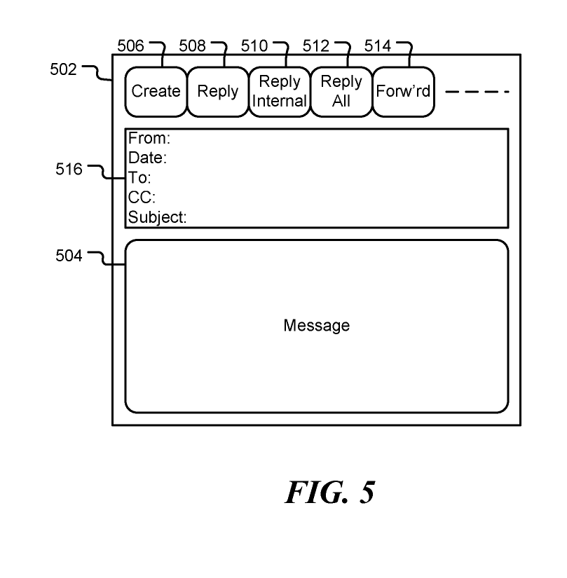

FIG. 5 is a diagrammatic representation of an exemplary graphical user interface in accordance with some embodiments of the invention. In this example, the graphical user interface 502 displays a received message in a pane 504. The graphical user interface 502 also displays a number of user-action elements, which include buttons 506, 508, 510, 512 and 514 in this example. It will be apparent to those of ordinary skill in the art that other user-action elements may be displayed. Also displayed is header information 516. The header information 516 identifies the sender of the message in a ‘From’ field and a list of other recipients in a ‘CC’ field. In prior messaging systems, the user is presented with an option to reply only to the sender. This action is selected by activating the ‘Reply’ button 508. The user is also presented with an option to reply to the sender and all of the addresses in the ‘CC’ list. This action is selected by activating the ‘Reply All’ button 512. This action generates a distribution list that contains the addresses of the sender and all of the other recipients in the ‘CC’ or ‘To’ list. In accordance with one embodiment of the present invention, at least one additional option is presented to the user via the ‘Reply Internal’ button 510. This action generates a distribution list that contains the addresses that are listed in the ‘From’, ‘To’ or ‘CC’ list and are internal to the user's organization. Thus, addresses that are not internal to the user's organization are not placed in the distribution list for the response message.

In the example shown in FIG. 5, a ‘Reply Internal’ button is presented. Additional or alternate user-action elements may be presented to allow the user to respond to predefined or user-defined groups or domains.

In an alternate embodiment, the ‘Reply Internal’ option is presented as a sub-option of the ‘Reply All’ element. That is, if the user selects the ‘Reply All’ option, he or she is then presented with a choice to reply to complete distribution list or one or more predefined or user-defined groups or domains.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for controlling dissemination of information in an electronic messaging system, the method comprising:
generating a first distribution list for a first message;
presenting a first user-action element to a user of the electronic messaging system, the first user-action element being indicative of whether the first message is to be sent to all recipients in the first distribution list;
presenting a second user-action element to the user of the electronic messaging system, the second user-action element being indicative of whether the first message is to be sent to a subgroup of the recipients in the first distribution list;
if the second user-action element is activated, removing from the first distribution list any recipients that are not included in a pre-defined set of the recipients to obtain a second distribution list that is a subgroup of the first distribution list; and
sending the first message to recipients in the first distribution list if the first user-action element is activated or to recipients in the second distribution list if the second user-action element is activated.

2. A method in accordance with claim 1, wherein the first message is a response to a received message and wherein generating a first distribution list for the first message comprises forming a list comprising the address of the sender of the received message and addresses of recipients to whom the received message was addressed or copied.

3. A method in accordance with claim 1, wherein the first user-action element comprises a ‘Reply All’ element and the second user-action element comprises a ‘Reply Subgroup’ element.

4. A method in accordance with claim 1, wherein the second distribution list comprises recipients in the first distribution list that are also internal to an organization of which the user is a member, and wherein the second user-action element conveys this meaning to the user.

5. A method in accordance with claim 1, wherein the second distribution list comprises recipients in the first distribution list that are also in the same message domain as the user.

6. A method in accordance with claim 1, wherein the second distribution list comprises recipients in the first distribution list that also are listed in an address list.

7. A method in accordance with claim 6, wherein the address list is compiled by the user.

8. A method in accordance with claim 1, wherein the second user-action element comprises an image on a graphical user interface.

9. A method in accordance with claim 1, wherein the second user-action element comprises a voice prompt generated by a voice entry interface.

10. A method in accordance with claim 1, wherein the electronic message system is selected from the group consisting of an electronic mail (email) system, a small message service (SMS), multimedia messaging system (MMS), or instant messaging (IM) system.

11. A method in accordance with claim 1, wherein removing from the first distribution list any recipients that are not also included in the pre-defined set of recipients is performed by a network server.

12. A method in accordance with claim 1, wherein removing from the first distribution list any recipients that are not also included in the pre-defined set of recipients is performed by a user device.

13. A method in accordance with claim 1, wherein a message comprises an element selected from the group of elements consisting of text, voice, diagrams, drawings, icons, images, video clips, audio and ring tones.

14. A method in accordance with claim 1, further comprising pre-configuring the presentation and actions of the first and second user-action elements.

15. A method in accordance with claim 14, presenting a user interface to enable the user to modify the presentation and actions of the first and second user-action elements.

16. A method for controlling dissemination of information in an electronic messaging system, the method comprising:
determining a first distribution list for a first message;
presenting a first user-action element to a user of the electronic messaging system, the first user-action element being indicative of whether the first message is to be sent to all recipients in the first distribution list;
presenting a second user-action element to the user of the electronic messaging system, the second user-action element being indicative of whether the first message is to be sent to a subgroup of the recipients in the first distribution list;
if the second user-action element is activated, identifying to the user any recipients that are not included in a pre-defined set of recipients;
enabling the user to remove any identified recipients from the first distribution list to obtain a second distribution list; and
sending the first message to recipients in the first distribution list if the first user-action element is activated and to recipients in the second distribution list if the second user-action element is activated.

17. A method in accordance with claim 16, wherein the first message is a response to a received message and wherein generating a first distribution list for a message comprises forming a list comprising the address of the sender of the received message and addresses of recipients to whom the received message was addressed or copied.

18. A method in accordance with claim 16, wherein the first user-action element comprises a ‘Reply All’ element and the second user-action element comprises a ‘Reply Subgroup’ element.

19. An electronic messaging system comprising:
an input for receiving a first distribution list for a first message;
a user communication device able to present to a user of the electronic messaging system a first user-action element, indicative of whether the first message is to be sent to all recipients in the first distribution list, and a second user-action element indicative of whether the first message is to be sent to a subgroup of the recipients in the first distribution list;
a processor that removes, from the first distribution list, any recipients that are not included in a pre-defined set of the recipients to obtain a second distribution list if the second user-action element is activated; and
an output for sending the first message to recipients in the first distribution list if the first user-action element is activated and to recipients in the second distribution list if the second user-action element is activated.

20. An electronic messaging system in accordance with claim 19, wherein the processor is incorporated in a network device of the electronic messaging system.

21. An electronic messaging system in accordance with claim 20, wherein the network device is a device selected from a group of devices consisting of an e-mail server, a messaging center and a messaging register.

22. An electronic messaging system in accordance with claim 19, wherein the processor is incorporated in the user communication device.

23. An electronic messaging system in accordance with claim 19, wherein the user communication device is a device selected from the group of devices consisting of a computer, a personal digital assistant, a cellular telephone and a personal communicator.

24. An electronic messaging system in accordance with claim 19, wherein the subgroup of recipients comprises recipients in a selected set of domains.

25. An electronic messaging system in accordance with claim 19, wherein the subgroup of recipients comprises recipients in a selected distribution list.
